(19) United States
(12) Patent Application Publication
(10) Pub. No.: US 2003/0197320 A1
(43) Pub. Date: Oct. 23, 2003

(54) Method and system for minimizing the amount of paper utilized by a network printer

(76) Inventor: Robert S. Hoblit, Knightdale, NC (US)

Correspondence Address: SAWYER LAW GROUP, P.O. Box 51418, Palo Alto, CA, 94303, US

(21) Appl. No.: 10/125,709

(22) Filed: Apr. 18, 2002

(51) Int. Cl. B41F 13/54

(52) U.S. Cl. 270/1.01

(57) ABSTRACT

The present invention relates to a method and system for reducing the amount of paper usage when multiple users are printing to one or more network printers. In part, for one aspect, a method and system is provided that comprises providing at least one print job, comprising a plurality of pages, and dividing a page of the plurality of pages into first and second sections, utilizing a perforation. In so doing, less paper is wasted resulting in savings in direct purchases of the paper.

### FIELD OF THE INVENTION

The present invention relates to network printer output and more specifically to a method and system for reducing the amount of paper usage when multiple users are printing to one or more network printers.

### BACKGROUND OF THE INVENTION

Many offices typically have several or a large number of computers linked to one or more network printers. When multiple users of these computers print documents to one or more of the network printers, typically a printer banner page must be printed for each individual print job in order to identify the owner of each set of document output pages. FIG. 1 is a block diagram illustrating print jobs 12a-12c which have been printed by a network printer 10, the first page 14a-14c of each print job 12a-12c comprising a separate banner page 14a-14c and output pages 15a-15c which contain the text of the desired documents. FIG. 2 illustrates a print job 12 which includes a banner page 14 and an output page 15. The banner 14 also serves as a separator between individual print jobs. The banner page 14 typically contains text identifying the owner of the document. The banner page may also be printed on paper of varying single colors. If the paper is of a different color than the output text pages, typically the banner paper will be loaded in a separate print tray of the printer.

The use of separate banner sheets of paper results in a waste of paper, since each sheet of banner paper is typically used only as an identification and sorting mechanism and is then discarded. This problem has been addressed partially by U.S. Pat. No. 5,316,279 ('279 patent), dated May 31, 1994, and assigned to Xerox Corporation. The '279 patent describes a system whereby banner pages may be perforated in order to separate the banner portion from the output or text portion of the page. However, in this system there is still difficulty in identifying one print job from another due to the lack of contrast between the pages. Hence, the separation of one print job from another may not be readily apparent. Accordingly, what is needed is a system and method for identifying different users' output from a network printer without having to print separate banner sheets of paper, thereby resulting in less paper waste as well as direct savings on paper purchases. In addition, there should be a clear indication that a new print job has been delivered. The present invention addresses such a need.

### SUMMARY OF THE INVENTION

In a first aspect, a method and system for minimizing the amount of paper utilized by a network printer is disclosed. The method and system comprises providing at least one print job, the at least one print job comprising a plurality of pages; and dividing a page of the plurality of pages into first and second sections, utilizing a perforation. In the method and system, one of the first and second sections includes banner text and the other of the first and sections includes an output text related to the print job. The output text is printed on a portion of the sheet of paper that is one color, and the section which includes the banner text is printed on a portion of the sheet of paper which is of another color.

In a second aspect, a page of a print job for use in a network printer is disclosed. The page comprises a first section, a second section, and a perforation coupled to and dividing the first and second sections, wherein banner text is provided on one of the first and second sections and an output text is provided on the other of the first and second sections, wherein the output text is printed on a portion of the sheet of a paper which is one color, and the section which includes the banner text is printed on a portion of the sheet of paper which is of another color.

In a method and system in accordance with the present invention, a perforation is added to a last sheet of a print job, such that the sheet can be separated into first and second sections. The banner text can then be placed on one section to identify the recipient of the print job and the other section can contain the output page of the print job. In so doing, less paper is wasted resulting in savings in direct purchases of the paper.

### BRIEF DESCRIPTION OF THE DRAWINGS

FIG. 1 is a block diagram illustrating print jobs which have been printed by a network printer, the first page of each print job consisting of a separate banner page.

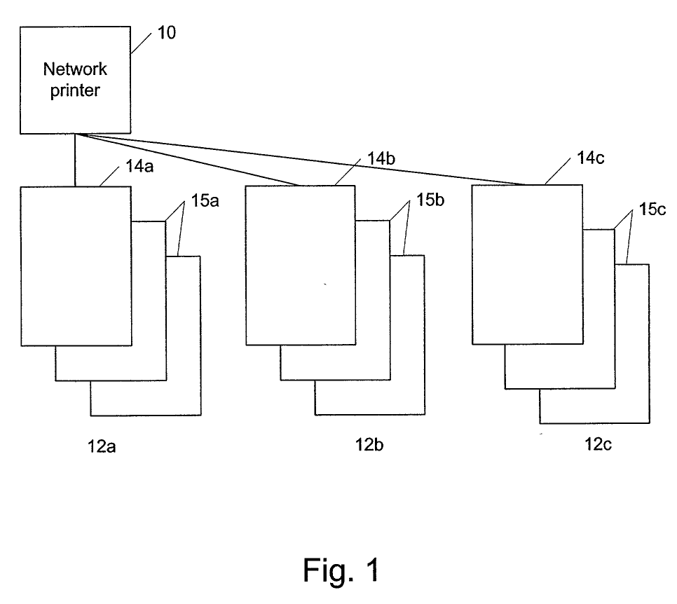

FIG. 2 illustrates a print job that includes a banner page and an output page.

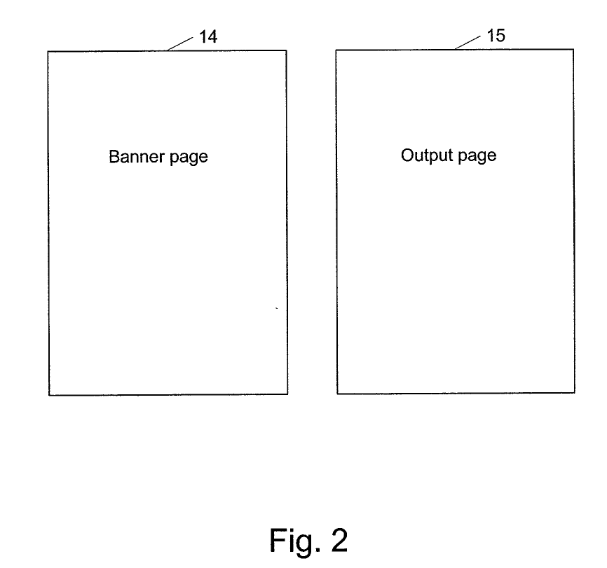

FIG. 3 is an illustrative embodiment of a first page of a print job in accordance with the present invention.

FIG. 4 illustrates a second embodiment of a first page of a print job in accordance the present invention.

FIG. 5 illustrates a third embodiment of the present invention of a first page of a print job in accordance with the present invention.

FIG. 6 illustrates a fourth embodiment of the present invention of a first page of a print job in accordance with the present invention.

FIG. 7 illustrates a fifth implementation of the present invention, in which the banner portion of the first page of the print job would be manufactured in a color other than white.

### DETAILED DESCRIPTION

The present invention relates to network printer output and more specifically to a method and system for reducing the amount of paper usage when multiple users are printing to one or more network printers. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a method and system in accordance with the present invention, a perforation is added to a two-toned page (i.e., a sheet of paper of two colors or of one color and white) of the print job, such that the two-toned sheet of paper can be separated into first and second sections. The banner text can then be placed on a section of the paper which is one color to identify the recipient of the print job, and the other section of the two-toned paper which is a second color can contain the output page of the print job. The remaining pages of the print job would be in a conventional manner/can be provided thereafter.

By utilizing two-toned sheets of paper, new or modified printing hardware is not needed. Only the software printer driver may need to be modified. It would also be possible to print the last two-toned page that contains the banner text in a different orientation than the output text of the print job. In so doing, less paper is wasted resulting in savings in direct purchases of the paper. To more particularly describe the present invention in the context of a specific embodiment, refer now to the following description in conjunction with the accompanying figures.

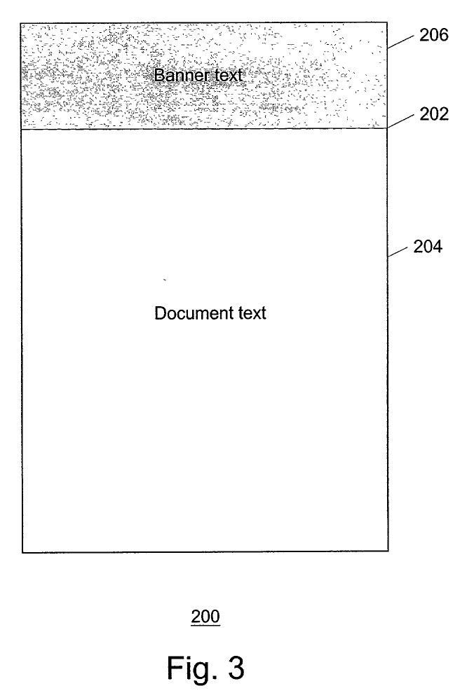

FIG. 3 is an illustrative embodiment of a page comprising a two-toned sheet of paper of a print job in accordance with the present invention. In a preferred embodiment of a method and system in accordance with the present invention, a perforation 202 is added to a two-toned sheet of paper 100 (8.5 inches×14 inches) such that when the two portions of the paper are separated at the perforation, one of the resulting sheets 104, which is used for the first page of the desired printed document, is 8.5×11 inches, and comprises one color. In a preferred embodiment a strip of tape or glue is provided on the perforation to strengthen it. In so doing the damage to the perforation would be minimized. The shorter 3-inch sheet 106, comprising a second color, serves the purpose of an identifying banner in order to indicate the originator of the print job and also to separate print jobs from one other. The shorter portion of the sheet 106 may contain identifying banner text.

In a first embodiment, the two toned paper could be purchased from a vendor. In a second embodiment, the two toned paper could be produced by the printer. Hence, a white sheet could be utilized such that when printed by the printer the background of the banner portion is shaded in a different color by the printer. size paper (8.5 inches×14 inches) is the preferred embodiment of the present invention, since legal size paper is the next larger standard paper size after letter size paper (8.5 inches×11 inches) which current printer hardware can print to without modification. Any other size of two-toned paper, such as but not limited to A4 size, which has similar perforations serving to divide a single sheet of paper into a main content sheet of one color and a separate banner portion of another color could be utilized, however.

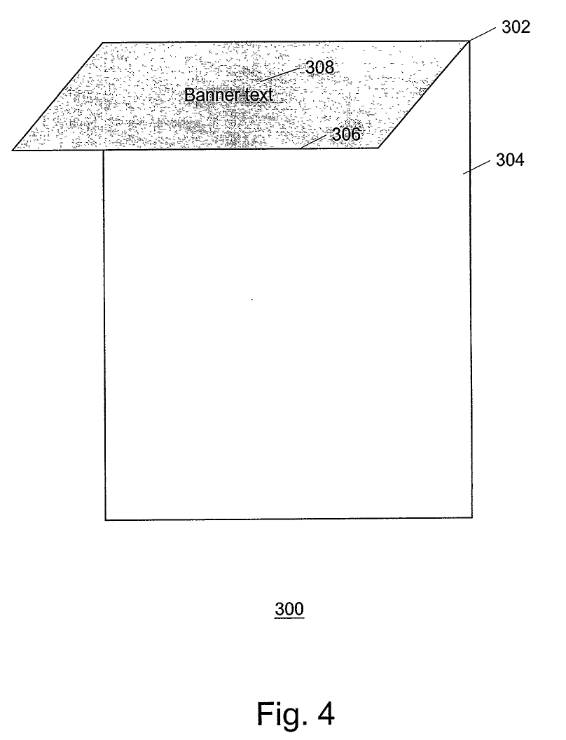

FIG. 4 illustrates a second embodiment of a two-toned page of a print job in accordance with the present invention. In this second embodiment, if a network printer supports two-sided printing, the banner text 308 could also be printed on the back side at the top of the sheet of two-toned paper 300 as the last sheet of each print job, so that the banner 306 could be folded over on the perforation 302 to display the banner 306, yet allow for sorting of the output by user, utilizing the users' current facilities. In this embodiment the last page of the document 304 would appear partially beneath the top portion of the folded banner portion 306 of the paper.

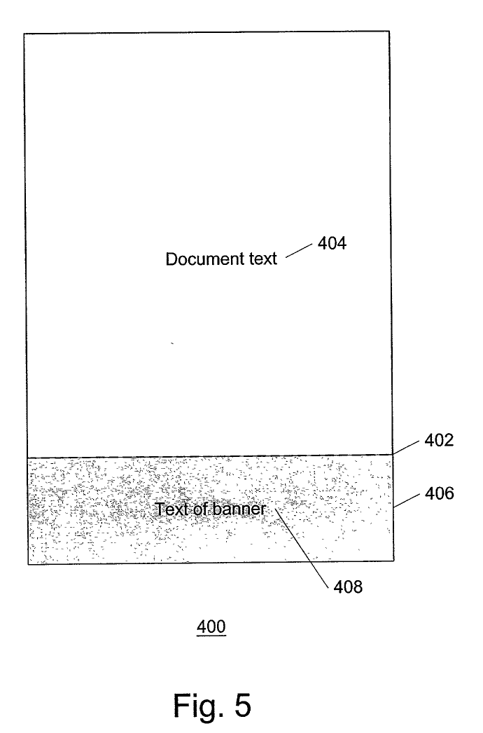

FIG. 5 illustrates a third embodiment of a two-toned page of a print job in accordance with the present invention. In this third embodiment, the perforation 402 might be placed at the bottom of the sheet of paper 400 on the same side of the paper as the document text 404. The printing of the banner text 408 could be printed on the banner portion of the paper 406 at the bottom of the page 400.

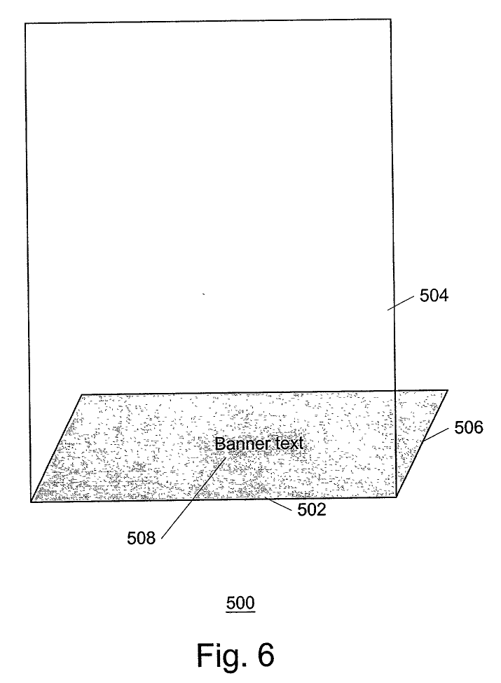

FIG. 6 illustrates a fourth embodiment of a two-toned page of a print job in accordance with the present invention. In this embodiment, the banner text 508 could be vertically inverted on the back side of the sheet of paper 500 beneath the perforation 502 at the bottom of the page, so that it could be clearly read if the banner portion 506 were folded under sheet of paper 500 so as to appear in front and at the bottom of the last page of the print job.

The third and fourth embodiments as above-described have the additional advantage of allowing a crisp edge to be maintained on the top edge of the sheet, since in utilization of these embodiments the perforated banner portion would be removed from the bottom of the page.

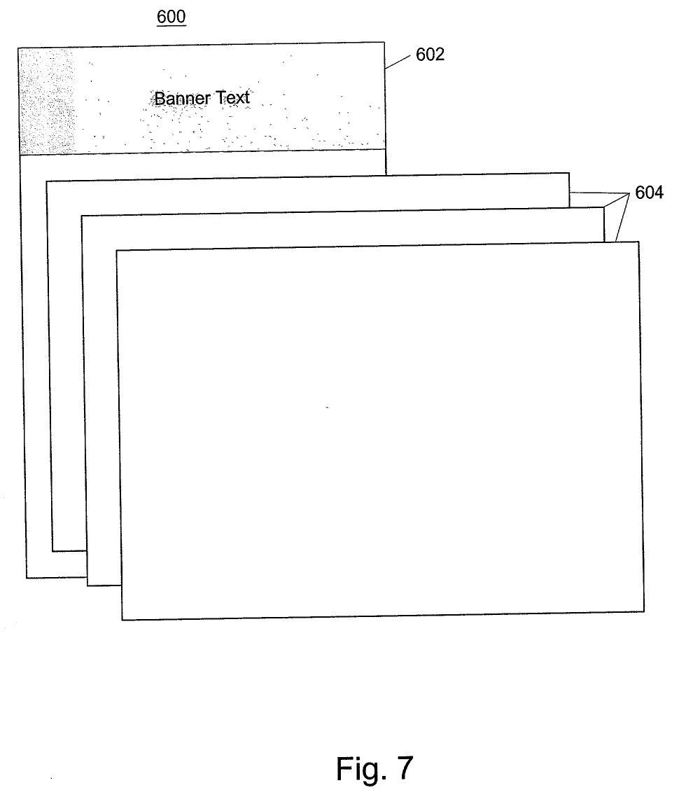

FIG. 7 illustrates a fifth implementation of the present invention in which the two-toned sheet of paper 600 which constitutes the last page of the print job, and which includes the banner text 602, would be printed in an orientation different from that of the preceding output text page or pages 604.

Accordingly, a method and system in accordance with the present invention would save approximately 64 percent of all paper used for banner printing, thereby providing direct savings in paper purchase costs as well as reducing paper waste.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for minimizing the amount of paper utilized by a network printer comprising the steps of:
(a) providing at least one print job, the at least one print job comprising a plurality of pages; and
(b) dividing a page of the plurality of pages into first and second sections, utilizing a perforation; wherein one of the first and second sections includes banner text and the other of the first and second sections includes an output text related to the print job, wherein the output text is printed on a section of the sheet of paper which is one color, and the banner text is printed on a section of the sheet of paper which is of another color.

2. The method of claim 1 wherein the page comprises a white sheet and the network printer prints the background of the section that includes the banner text in another color.

3. The method of claim 1 wherein the page comprises a two-toned sheet.

4. The method of claim 1 wherein the first and second sections comprise a top section and a bottom section.

5. The method of claim 4 in which the banner text is printed on a backside of the top section.

6. The method of claim 4 in which the banner text is printed on a front side of the bottom section.

7. The method of claim 4 in which the banner text is printed on a backside of the bottom section.

8. The method of claim 1 wherein the page is the last page of the print job.

9. The method of claim 1 wherein the page is printed in an orientation different from that of the output text.

10. The method of claim 1 wherein an adhesive reinforces the perforation.

11. A page of a print job for use in a network printer comprises:
a first section;
a second section; and
a perforation coupled to and dividing the first and second sections; wherein banner text is provided on one of the first and second sections and an output text is provided on the other of the first and second sections, wherein the output text is printed on a portion of the sheet of paper which is one color, and the section which includes the banner text is printed on a portion of the sheet of paper which is of another color.

12. The page of claim 11 wherein the page comprises a white sheet and the network printer prints the background of the section that includes the banner text in another color.

13. The page of claim 11 wherein the page comprises a two-toned sheet.

14. The page of claim 11 wherein the first and second sections comprise a top section and a bottom section.

15. The page of claim 14 in which the banner text is printed on a backside of the top section.

16. The page of claim 14 in which the banner text is printed on a front side of the bottom section.

17. The page of claim 14 in which the banner text is printed on a backside of the bottom section.

18. The page of claim 11 wherein the page is the last page of the print job.

19. The page of claim 11 wherein the page is printed in an orientation different from that of the output text.

20. The page of claim 11 wherein an adhesive reinforces the perforation.
